(19) United States
(12) Patent Application Publication
(10) Pub. No.: US 2011/0151894 A1
(43) Pub. Date: Jun. 23, 2011

(54) COMMUNICATION DEVICE AND METHOD FOR PROMPTING INCOMING EVENTS OF THE COMMUNICATION DEVICE

(75) Inventor: CHIN-LIN YANG, Tu-Cheng (TW)

(73) Assignee: CHI MEI COMMUNICATION SYSTEMS, INC., Tu-Cheng City (TW)

(21) Appl. No.: 12/712,383

(22) Filed: Feb. 25, 2010

(30) Foreign Application Priority Data
Dec. 17, 2009 (CN) 200910311733.6

(51) Int. Cl. H04W 64/00

(52) U.S. Cl. 455/456.6

(57) ABSTRACT

A communication device and method for prompting incoming events of the communication device are provided. The method monitors environment situation around the communication device when the communication device receives an incoming event, and determines an environment mode of the communication device according to the environment situation. The method further searches a storage system of the communication device for a prompt mode matching the environment mode, and prompts a user using the prompt mode so as to avoid urgent or important events.

### BACKGROUND

1. Technical Field

Embodiments of the present disclosure relate generally to communication devices, and more particularly to a communication device and a method for prompting incoming events of the communication device.

2. Description of Related Art

Urgent or important events (e.g., incoming calls) are often missed because of an improper event prompt of a communication device. For example, urgent or important calls may be missed when a person is walking along a noisy street, because the ringtone of the communication device was not loud enough.

Therefore, there is a need for an improved communication device and method for prompting an incoming event to address the above-mentioned problems.

### BRIEF DESCRIPTION OF THE DRAWINGS

FIG. 1 is a block diagram of one embodiment of a communication device.

FIG. 2 is a block diagram of one embodiment of a monitoring unit of the communication device in FIG. 1.

FIG. 3 is a schematic table of one embodiment of prompt modes of various environment modes.

FIG. 4 is a flowchart of one embodiment of a method for prompting an incoming event of the communication device of FIG. 1.

FIG. 5 is a flowchart of detailed descriptions of block S02 of FIG. 4.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one. In one embodiment of the present disclosure, incoming events may be incoming calls, incoming messages, alarm clock events, or any other events need to prompt users.

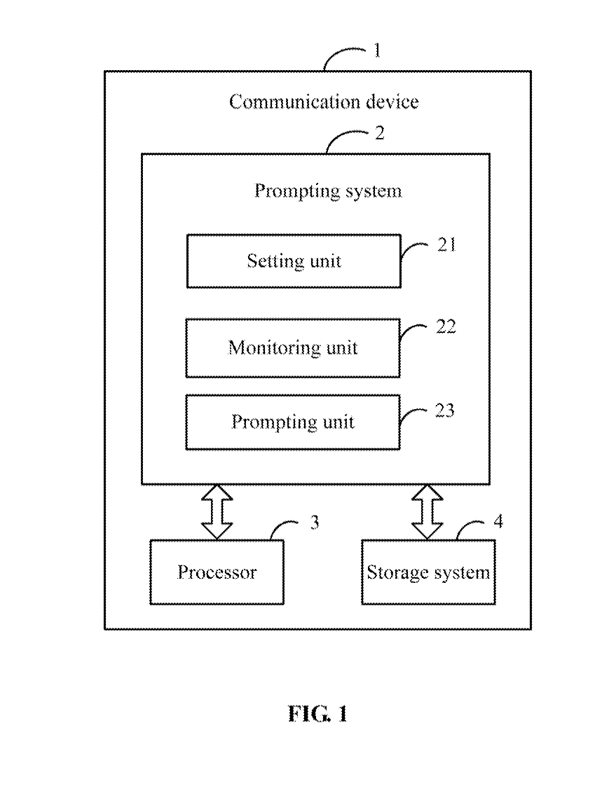

FIG. 1 is a block diagram of one embodiment of a communication device 1. In the embodiment, the communication device 1 may include a prompting system 2, a processor 3, and a storage system 4. In one embodiment, the communication device 1 may be a mobile phone, or a personal digital assistant, for example. It should be apparent that FIG. 1 is only one example of the communication device 1 architecture that can be included with more or fewer components than shown in other embodiments, or a different configuration of the various components.

The processor 3 executes one or more computerized operations of the communication device 1 and other applications, to provide communication functions of the communication device 1. The storage system 4 stores one or more programs, such as an operating system, and other applications of the communication device 1. In one embodiment, the storage system 4 may be a random access memory (RAM) for temporary storage of information, and/or a read only memory (ROM) for permanent storage of information. In other embodiments, the storage system 4 may also be an external storage device, such as a hard disk, a storage card, or a data storage medium.

In one embodiment, the prompting system 2 includes a setting unit 21, a monitoring unit 22, and a prompting unit 23. One or more computerized codes of the function units 21-23 may be stored in the storage system 4, and can be executed by the processor 3 to perform communication operations of the communication device 1.

The setting unit 21 sets a prompt mode for each environment mode of the communication device 1 according to user requirements, and stores the set prompt mode in the storage system 4 of the communication device 1. Each environment mode is predefined according to an environment situation around the communication 1. The environment situation may be determined by a current system time of the communication device 1, a moving status of the communication device 1, an environmental volume level around the communication device 1, and an illumination intensity of the environment, for example.

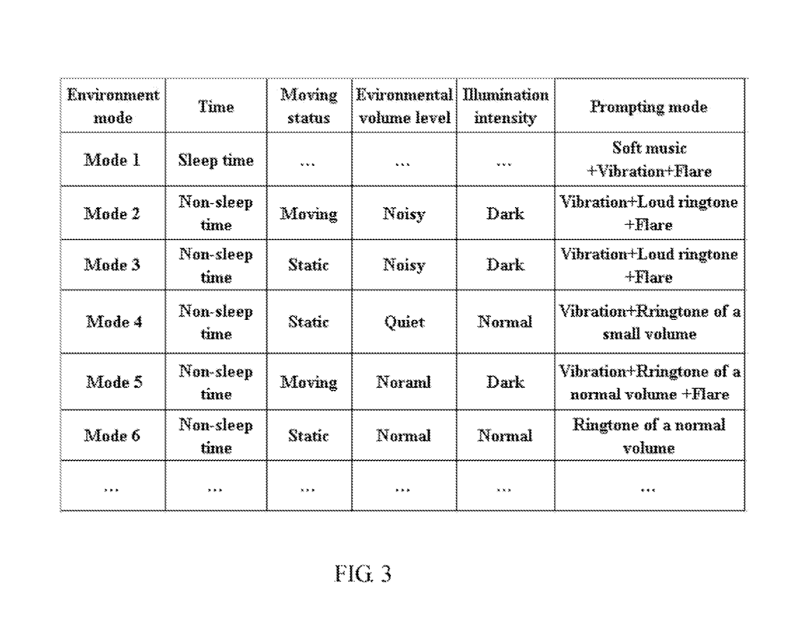

In one example with respect to FIG. 3, is a schematic table of one embodiment of different prompt modes corresponding to various environment modes. For example, if the current system time of the communication device 1 is sleep time, the environment mode may be a first environment mode (i.e., Mode1 in FIG. 3), and the prompt mode of the first environment mode may be composed of soft music, vibrations, and flares. If the current system time is non-sleep time, the moving status of the communication device 1 is moving, the environmental volume level is noisy, and the illumination intensity of the environment is dark, the environment mode of the communication device 1 may be a second environment mode (i.e., Mode2 in FIG. 3). The prompt mode of the second environment mode may be composed of vibrations, a loud ringtone, and flares, for example. In the embodiment, if the prompt mode is not preset for each environment mode, a default prompt mode stored in the storage system 4 may be defined as the prompt mode for each environment mode.

The monitoring unit 22 monitors the environment situation around the communication device 1 when the communication device 1 receives an incoming event, and determines an environment mode of the communication device 1 according to the environment situation. Further details of the monitoring unit 22 is provided below.

The prompting unit 23 searches the storage system 4 for a prompt mode matching the environment mode, and prompts the user using the prompt mode, so as to avoid missing urgent or important events.

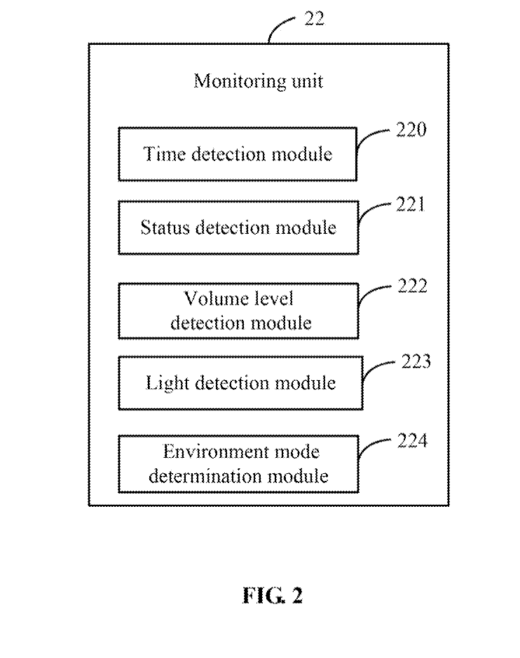

FIG. 2 is a block diagram of one embodiment of the monitoring unit 22 of FIG. 1. In one embodiment, the monitoring unit 22 includes a time detection module 220, a status detection module 221, a volume level detection module 222, a light detection module 223, and an environment mode determination module 224. In general, the words “unit” and “module,” as used herein, refers to logic embodied in hardware or firmware, or to a collection of software instructions, written in a programming language, such as, Java, C, or Assembly. One or more software instructions in the units or modules may be embedded in firmware, such as an EPROM. The units and modules described herein may be implemented as either software and/or hardware units or modules and may be stored in any type of computer-readable medium or other storage device.

The time detection module 220 detects the current system time of the communication device 1, and detects which time period the current system time is in. In one embodiment, the system time of the communication device 1 is divided into two periods, such as sleep time and non-sleep time. For example, 23:00 to 06:00 may predefine as sleep time, and the other time may predefine as non-sleep time. In other embodiments, the system time of the communication device 1 may be divided into other times, such as working hours and non-working hours.

The status detection module 221 obtains detection data of the communication device 1, and detects the moving status of the communication device 1 according to the detection data. The status detection module 221 may obtain the detection data by using a G-sensor, or a gyroscope equipped into the communication device 1. The moving status of the communication device 1 may be detected as moving or static according to the detection data. In one embodiment, the detection data may be an acceleration of the communication device 1 detected by the G-sensor. If the acceleration of the communication device 1 is greater than a threshold value, such as 2 N/kg, the moving status may be detected as moving, or the moving status may be detected as static.

The volume level detection module 222 detects the environmental volume level around the communication device 1. In one embodiment, the volume level detection module 222 may be a decibel meter to measure an environmental volume around the communication device 1. The environmental volume level may be detected as quiet, normal, or noisy. In one embodiment, if the environmental volume measured by the decibel meter is less than 30 db, the environmental volume level may be detected as quiet. If the environmental volume is greater than 30 db and less than 60 db, the environmental volume level may be detected as normal. If the environmental volume is greater than 60 db, the environmental volume level may be detected as noisy.

The light detection module 223 detects the illumination intensity of the environment around the communication device 1. In one embodiment, the light detection module 223 may be a photometer. The illumination intensity of the environment around the communication device 1 may be normal or dark according to a detection result of the photometer.

The environment mode determination module 224 determines the environment mode of the communication device 1 according to the detection results of the modules 220-224. For example, if the current system time of the communication device 1 is non-sleep time, the moving status of the communication device 1 is static, the environmental volume level is noisy, and the illumination intensity of the environment is dark, the environment mode may be determined as a third environment mode (i.e., Mode3 in FIG. 3). If the current system time is non-sleep time, the moving status of the communication device 1 is static, the environmental volume level is quiet, and the illumination intensity of the environment is normal, then the environment mode of the communication device 1 may be determined as a fourth environment mode (i.e., Mode4 in FIG. 3).

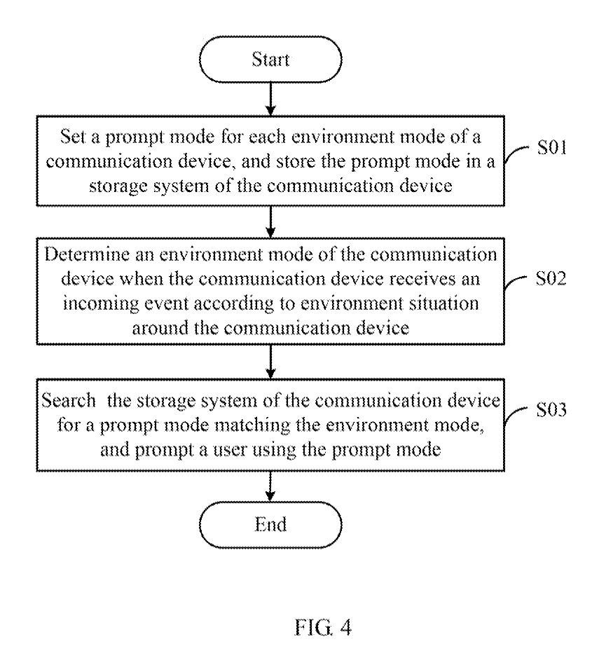

FIG. 4 is a flowchart of one embodiment of a method for prompting an incoming event of the communication device 1 of FIG. 1. Depending on the embodiment, additional blocks may be added, others removed, and the ordering of the blocks in FIG. 4 may be changed.

In block S01, the setting unit 21 sets a prompt mode for each environment mode of the communication device 1 according to user requirements, and stores the set prompt mode in a storage system 4 of the communication device 1.

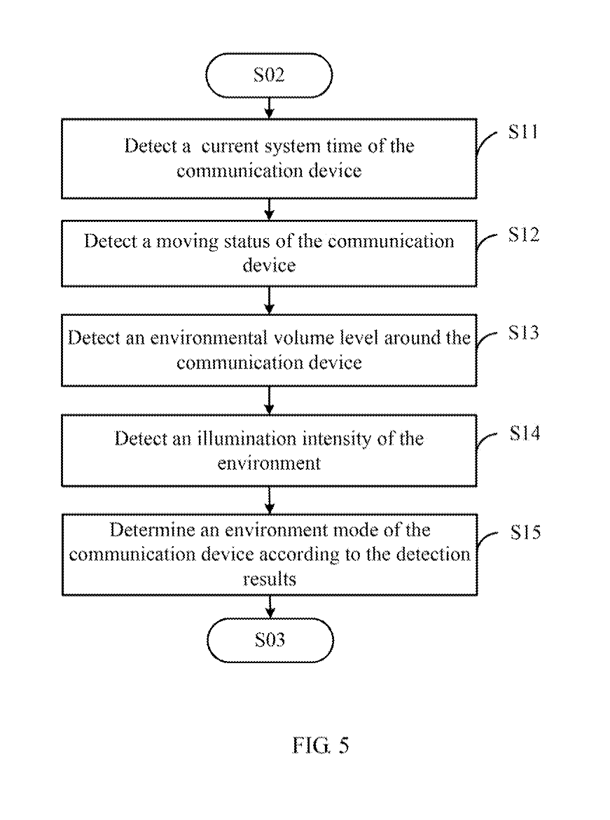

In block S02, the monitoring unit 22 monitors environment situation around the communication device 1 when the communication device 1 receives an incoming event, and determines an environment mode of the communication device 1 according to the environment situation. Details of the environment mode determination are described as shown in FIG. 5 below.

In block S03, the prompting unit 23 searches the storage system 4 for a prompt mode matching the environment mode, and prompts a user using the prompt mode.

FIG. 5 is a flowchart of detailed descriptions of block S02 of FIG. 4. Depending on the embodiment, additional blocks may be added, others removed, and the ordering of the blocks in FIG. 5 may be changed.

In block S11, the time detection module 220 detects a current system time of the communication device 1, and detects which time period the current system time is in. In one embodiment, the system time of the communication device 1 is divided into two periods, such as sleep time and non-sleep time. For example, 23:00 to 06:00 may predefine as sleep time, and the other time may predefine as non-sleep time. In other embodiments, the system time of the communication device 1 may be divided into other times, such as working hours and non-working hours.

In block S12, the status detection module 221 detects a moving status of the communication device 1. The moving status of the communication device 1 may be detected as moving or static.

In block S13, the volume level detection module 222 detects the environmental volume level around the communication device 1. The environmental volume level may be detected as quiet, normal, or noisy.

In block S14, the light detection module 223 detects the illumination intensity of the environment around the communication device 1. The illumination intensity of the environment around the communication device 1 may be detected as normal or dark.

In block S15, the environment mode determination module 224 determines the environment mode of the communication device 1 according to the detection results of block S11 to block S14. For example, if the current system time of the communication device 1 is non-sleep time, the moving status of the communication device 1 is static, the environmental volume level is noisy, and the illumination intensity of the environment is dark, the environment mode may determine a third environment mode(i.e., Mode3 in FIG. 3). If the current system time is non-sleep time, the moving status of the communication device 1 is static, the environmental volume level is quiet, and the illumination intensity of the environment is normal, then the environment mode of the communication device 1 may determine a fourth environment mode (i.e., Mode4 in FIG. 3). Each environment mode matches a prompt mode that is stored in the storage system 4. As such, when the communication device 1 receives an incoming event, the communication device 1 prompts the user in a proper prompt mode according to the environment situation, so as to avoid missing urgent or important events.

All of the processes described above may be embodied in, and fully automated, via functional code modules executed by one or more general purpose processors of a communication device. The functional code modules may be stored in any type of readable medium or other storage devices. Some or all of the methods may alternatively be embodied in specialized communication devices.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method for prompting incoming events of a communication device, comprising:
(a1) monitoring environment situation around the communication device when the communication device receives an incoming event, and determining an environment mode of the communication device according to the environment situation;
(a2) searching a storage system of the communication device for a prompt mode matching the environment mode, and prompting a user using the prompt mode.

2. The method according to claim 1, further comprising:
setting a prompt mode for each environment mode of the communication device; and
storing the set prompt mode in the storage system of the communication device.

3. The method according to claim 1, wherein the block (a1) comprises:
(b1) detecting a current system time of the communication device;
(b2) detecting a moving status of the communication device;
(b3) detecting an environmental volume level around the communication device;
(b4) detecting an illumination intensity of the environment; and
(b5) determining the environment mode of the communication device according to the detection results.

4. The method according to claim 1, wherein the incoming event is an incoming call, an incoming message, or an alarm clock event.

5. A communication device, the communication device comprising:
a storage system;
at least one processor; and
one or more programs stored in the storage system and being executable by the at least one processor, the one or more programs comprising:
a monitoring unit operable to monitor environment situation around the communication device when the communication device receives an incoming event, and determine an environment mode of the communication device according to the environment situation;
a prompting unit operable to search the storage system for a prompt mode matching the environment mode, and prompts a user using the prompt mode.

6. The communication device according to claim 5, wherein the one or more programs further comprises:
a setting unit operable to set a prompt mode for each environment mode of the communication device, and storing the set prompt mode in the storage system.

7. The communication device according to claim 5, wherein the monitoring unit comprises:
a time detection module operable to detect a current system time of the communication device;
a status detection module operable to detect a moving status of the communication device;
a volume level detection module operable to detect an environmental volume level around the communication device;
a light detection module operable to detect an illumination intensity of the environment; and
an environment mode determination module operable to determine the environment mode of the communication device according to the detection results of the aforementioned modules.

8. The communication device according to claim 5, wherein the incoming event is an incoming call, an incoming message, or an alarm clock event.

9. A storage medium storing a set of instructions, the set of instructions capable of being executed by a processor of a communication device to perform a method for prompting incoming events of the communication device, the method comprising:
(a1) monitoring environment situation around the communication device when the communication device receives an incoming event, and determining an environment mode of the communication device according to the environment situation;
(a2) searching a storage system of the communication device for a prompt mode matching the environment mode, and prompting a user using the prompt mode.

10. The storage medium as claimed in claim 9, wherein the method further comprises:
setting a prompt mode for each environment mode of the communication device; and
storing the set prompt mode in the storage system of the communication device.

11. The storage medium as claimed in claim 9, wherein the block (a1) comprises:
(b1) detecting a current system time of the communication device;
(b2) detecting a moving status of the communication device;
(b3) detecting an environmental volume level around the communication device;
(b4) detecting an illumination intensity of the environment; and
(b5) determining the environment mode of the communication device according to the detection results.

12. The storage medium as claimed in claim 9, wherein the incoming event is an incoming call, an incoming message, or an alarm clock event.
